(19) United States
(12) Patent Application Publication
(10) Pub. No.: US 2024/0394640 A1
(43) Pub. Date: Nov. 28, 2024

(54) METHOD AND SYSTEM FOR CALCULATING LEVEL OF FRICTION WITHIN A CUSTOMER AND AGENT INTERACTION, FOR QUALITY IMPROVEMENT THEREOF, IN A CONTACT CENTER

(71) Applicant: NICE LTD., Ra'anana (IL)

(72) Inventors: Matan KERET, Oulu (FI); Rahul VYAS, Jodhpur (IN); Salil DHAWAN, Pune (IN); Or GERSHON, Petah Tikva (IL)

(21) Appl. No.: 18/200,058

(22) Filed: May 22, 2023

(51) Int. Cl. G06Q 10/0639; G06Q 30/02

(52) U.S. Cl. CPC G06Q 10/06395; G06Q 30/0281

(57) ABSTRACT

A computerized-method for calculating a level of friction within a customer and agent interaction, for quality improvement thereof, in a multichannel contact center. The computerized-method includes operating, for each interaction between the customer and the agent, in each channel, an Interaction Friction Score (IFS) calculation module. The IFS calculation module includes retrieving a transcript and interaction metadata of the interaction between the customer and the agent from the friction datastore and the database of interactions transcripts and metadata. The transcript includes ‘N’ sentences and calculating an IFS of the interaction between the customer and the agent then forwarding each interaction between the customer and the agent having a calculated IFS above a calculated Interaction Friction Threshold (IFT) for an intervention.

### TECHNICAL FIELD

The present disclosure relates to the field of data analysis for evaluation in a quality management process in a contact center, according to a calculated factor.

### BACKGROUND

Businesses strive to provide high quality service, in contact centers, over omnichannel, such as: phone, email, social media, web chat and the like. First Call Resolution (FCR), also known as first contact resolution, is an important metric for monitoring customer service. However, when a query is being posted by a customer on any channel, there may be increased instances where an agent misinterprets the intent and the replies by the customer which may lead to an increased level of friction among the related parties.

The increased level of friction between parties may lead to increased repetitions of sentences and also to an incrementally increase in customer and agent frustration, which may impact the contact center efficiency, customer experience, agent morale and FCR.

If contact centers would have a technical solution that may provide information as to when there is such increased friction, then the contact centers may perform a timely or automated intervention. Therefore, there is a need for a technical solution to calculate a level of friction within an interaction between a customer and an agent in a contact center to allow other users in the contact center to timely intervene in the interaction and resolve issues that may have increased the level of friction.

Moreover, there is a need to detect fiction during agent-customer interactions on digital channels and flag relevant interactions for better quality management processes and restructure of the interaction on the multiple channels SUMMARY

There is thus provided, in accordance with some embodiments of the present disclosure, a computerized-method for calculating a level of friction within a customer and an agent interaction, for quality improvement thereof, in a multichannel contact center.

In accordance with some embodiments of the present disclosure, in a computerized system that includes one or more processors, a friction datastore and a database of interactions transcripts and metadata, and a memory to store the plurality of databases, the one or more processors may be configured to operate, for each interaction between the customer and the agent, in each channel, an Interaction Friction Score (IFS) calculation module.

Furthermore, in accordance with some embodiments of the present disclosure, the IFS calculation module may include retrieving a transcript and interaction metadata of the interaction between the customer and the agent from the friction datastore and the database of interactions transcripts and metadata. The transcript includes ‘N’ sentences. Then, the IFS calculation module may calculate an IFS of the interaction between the customer and the agent by formula I:

$$I F S = {\prod }_{2}^{N} ( {S}_{n - 1} + ( 1 - α ) ) \vert α , {S}_{n} ∈ [ 0 , 1 ] \qquad ( I )$$

whereby: N is the number of sentences in the transcript and
Sₙ is a friction score for sentence n, a is hyper parameter that represents a value that is attributed to a high level of friction; and then forwarding each interaction between the customer and the agent having a calculated IFS above a calculated Interaction Friction Threshold (IFT) for an intervention.

Furthermore, in accordance with some embodiments of the present disclosure, the Sₙ of each sentence may be calculated by a sentence-score module. The sentence-score module may include receiving a sentenceₙ, a person one-hot vector of sentenceₙ, and interaction time-offset of the sentenceₙ, a sentenceₙ₋₁, a person one-hot vector of sentenceₙ₋₁, and interaction time-offset of the sentenceₙ₋₁; then, calculating a friction-score for the sentence by: (i) providing the person one-hot vector of sentenceₙ and the person one-hot vector of sentenceₙ₋₁ to a Natural Language Processing (NLP) Turn-Talking model to yield probability vector prediction of sentenceₙ; (ii) calculating a vector-distance between a provided probability vector prediction of sentenceₙ and the person one-hot vector of sentenceₙ; (iii) providing the sentenceₙ₋₁ to next-sentence-prediction model to yield a predicted-sentenceₙ; (iv) embedding the predicted-sentenceₙ and sentenceₙ using an NLP-embedding-engine module to yield a predicted-sentenceₙ embedding and a sentenceₙ embedding; (v) calculating a distance between the yielded predicted-sentenceₙ embedding and the yielded sentenceₙ embedding; (vi) providing the interaction time-offset of the sentenceₙ₋₁ and interaction time-offset of the sentenceₙ to normalized-relative-offset-module to calculate a relative offset between sentenceₙ and sentenceₙ₋₁ by dividing a difference between sentenceₙ and sentenceₙ₋₁ by time-offset of sentenceₙ; and (vii) calculating a weighted average of the vector-distance, distance and the relative offset. The weighted average has a value between ‘0’ and ‘1’, and the weighted average may be the Sₙ of the sentenceₙ.

Furthermore, in accordance with some embodiments of the present disclosure, the distance is selected from Euclidean distance or Cosine distance.

Furthermore, in accordance with some embodiments of the present disclosure, the next-sentence-prediction model may be further provided sentences from sentence₁₊ₘ through sentenceₙ₋₁.

Furthermore, in accordance with some embodiments of the present disclosure, the next-sentence-prediction model may be implemented by an open-source artificial intelligence.

Furthermore, in accordance with some embodiments of the present disclosure, the open-source artificial intelligence may be Generative Pre-trained Transformer 2 (GPT2).

Furthermore, in accordance with some embodiments of the present disclosure, the embedding of the predicted-sentenceₙ and the sentenceₙ may be a learned vector representation for text.

Furthermore, in accordance with some embodiments of the present disclosure, the IFT may be calculated for each channel based on historic interactions scores operated in this channel in a preconfigured period.

Furthermore, in accordance with some embodiments of the present disclosure, the NLP Turn-Talking model and the next-sentence-prediction model may be trained on sentence samples which may be classified as ‘neutral’.

Furthermore, in accordance with some embodiments of the present disclosure, the intervention may include at least one of: (i) having a user intervene the interaction when the IFS module may be operated in real-time; (ii) sending the calculated IFS to a platform by which the platform is preconfigured to distribute the interaction for evaluation, based on the IFS; and (iii) sending the transcript of the interaction to an application to present via a User Interface (UI) segments of the interaction where each segment may be presented with the calculated IFS.

Furthermore, in accordance with some embodiments of the present disclosure, the application may present via the UI a visualization of ‘neutral’ segments and ‘negative’ segments.

Furthermore, in accordance with some embodiments of the present disclosure, the application may be a supervised dashboard, and the platform may be a Quality Management (QM) platform.

Furthermore, in accordance with some embodiments of the present disclosure, the transcript may be a transcript of a voice interaction or a text interaction.

Furthermore, in accordance with some embodiments of the present disclosure, the IFP calculation module may be a microservice having one or more instances thereof that operate in parallel.

Furthermore, in accordance with some embodiments of the present disclosure, the friction datastore may include two pats: a cache for ongoing interactions and a database to store classification of the interactions as ‘neutral’ or ‘negative’ and IFS score of interactions classified as ‘negative’.

Furthermore, in accordance with some embodiments of the present disclosure, the computerized-method may further include calculating an agent-IFS based on a preconfigured interactions from the database in the friction datastore in a preconfigured time for each agent and the agent-IFS of the agent may be used to categorize the agent based on one or more agent-preconfigured-thresholds.

Furthermore, in accordance with some embodiments of the present disclosure, the agent categorization may be used in a Workforce Management system when generating shift-schedules by having each generated shift-schedule including agents of two or more agent categorizations.

Furthermore, in accordance with some embodiments of the present disclosure, the agent categorization may be selected from: (i) ‘low’; (ii) ‘medium’; and (iii) ‘high’. When an agent categorization of the agent is below or equal to a first preconfigured-threshold of the one or more thresholds the agent may be categorized as ‘low’. When the agent categorization of the agent is above the first preconfigured-threshold of the one or more thresholds and below or equal a second preconfigured-threshold the agent may be categorized as ‘medium’ and when the agent categorization of the agent is above the second preconfigured-threshold of the one or more thresholds the agent may be categorized as ‘high’.

There is further provided, in accordance with some embodiments of the present invention, a computerized-system for calculating a level of friction within a customer and an agent interaction, for quality improvement thereof, in a multichannel contact center.

Furthermore, in accordance with some embodiments of the present disclosure, the computerized-system includes one or more processors, a database of data related to interaction metadata and a friction datastore and a memory to store the plurality of databases. The one or more processors may be configured to operate, for each interaction between the customer and the agent, in each channel, an Interaction Friction Score (IFS) calculation module.

Furthermore, in accordance with some embodiments of the present disclosure, the IFS calculation module may include retrieving a transcript and interaction metadata of the interaction between the customer and the agent from the friction datastore and the database of interactions transcripts and metadata. The transcript includes ‘N’ sentences. Then, calculating an IFS of the interaction between the customer and the agent by formula I:

$$I F S = {\prod }_{2}^{N} ( {S}_{n - 1} + ( 1 - α ) ) \vert α , {S}_{n} ∈ [ 0 , 1 ] \qquad ( I )$$

whereby: N is the number of sentences in the transcript and
Sₙ is a friction score for sentence n, a is hyper parameter that represents a value that is attributed to a high level of friction; and then the IFS calculation module may forward each interaction between the customer and the agent having a calculated IFS above a calculated Interaction Friction Threshold (IFT) for an intervention.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1A schematically illustrates a high-level diagram of a computerized-system for calculating a level of friction within a customer and an agent interaction, for quality improvement thereof, in a multichannel contact center, in accordance with some embodiments of the present invention;

FIG. 1B schematically illustrates a high-level work-flow on a computerized-system for calculating a level of friction within a customer and an agent interaction, for quality improvement thereof, in a multichannel contact center, in accordance with some embodiments of the present invention;

FIG. 2 is a schematic flowchart a computerized-method for calculating a level of friction within a customer and an agent interaction, for quality improvement thereof, in a multichannel contact center, in accordance with some embodiments of the present invention:

FIG. 3 is a schematic flowchart a computerized-method for calculating a level of friction within a customer and an agent interaction, for quality improvement thereof, in a multichannel contact center, in accordance with some embodiments of the present invention:

FIG. 4 is a schematic diagram of a system for calculating a level of friction within a customer and an agent interaction, for quality improvement thereof, in a multichannel contact center, in accordance with some embodiments of the present invention;

FIG. 5 is a diagram which illustrates agent categorization, in accordance with some embodiments of the present invention;

FIG. 6 is an example of interaction friction analysis, in accordance with some embodiments of the present invention:

FIG. 7 is an example of interaction inference, in accordance with some embodiments of the present invention;

FIG. 8 is a visualized interaction friction, in accordance with some embodiments of the present disclosure.

FIGS. 9A-9C are high-level work-flows of a computerized-method for calculating a level of friction within a customer and an agent interaction, for quality improvement thereof, in a multichannel contact center, in accordance with some embodiments of the present disclosure;

FIG. 10 is a schematic flowchart of a real-time friction analysis, in accordance with some embodiments of the present disclosure:

FIG. 11 is an example of visual friction dashboard, in accordance with some embodiments of the present disclosure; and

FIG. 12 is an example of an interface for IFS utilization to create a new quality plan, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating.” “determining” “establishing” “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “friction” as used herein, refers to one or more instances where an interaction between an agent and a customer has a delay in proceeding towards resolution of customer issue or the purpose that the customer has initiated the interaction for is not met.

The term “intervention” as used herein refers to one or more actions operated in real-time during an interaction or later on to reduce a calculated level of friction in current or future interactions.

The term vector-distance as used herein refers to measure of distance between embedding of sentenceₙ and embedding of predicted sentenceₙ and distance between person one-hot vector and predicted one-hot vector. The distance indicates how different the sentences, or the vectors from each other.

The term “channel” as used herein refers to a communication means that is used to provide service to customers, where the communication is based on voice or text. For example, voice calls, chat, email and the like.

Contact centers can improve their metrics, such as First Call Resolution (FCR), by taking one or more actions to create smooth customer journeys, and having as few as possible frictions during customer and agent interactions. Accordingly, there is a need for a technical solution for detecting and calculating a level of fiction within an interaction in a contact center, to allow a timely or automated intervention or to later on restructure the interaction on digital channels or to perform better quality management.

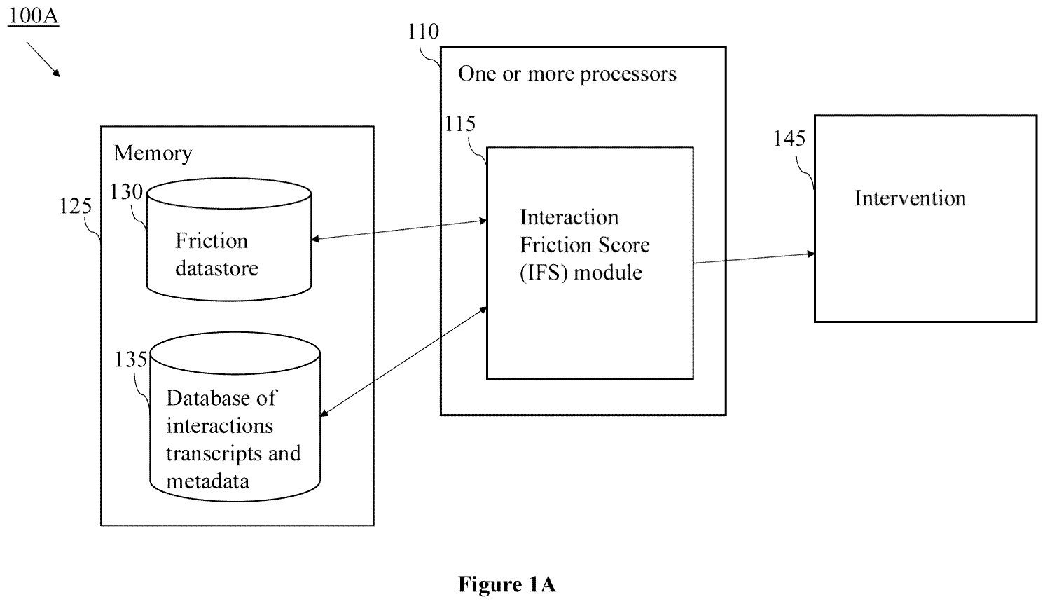

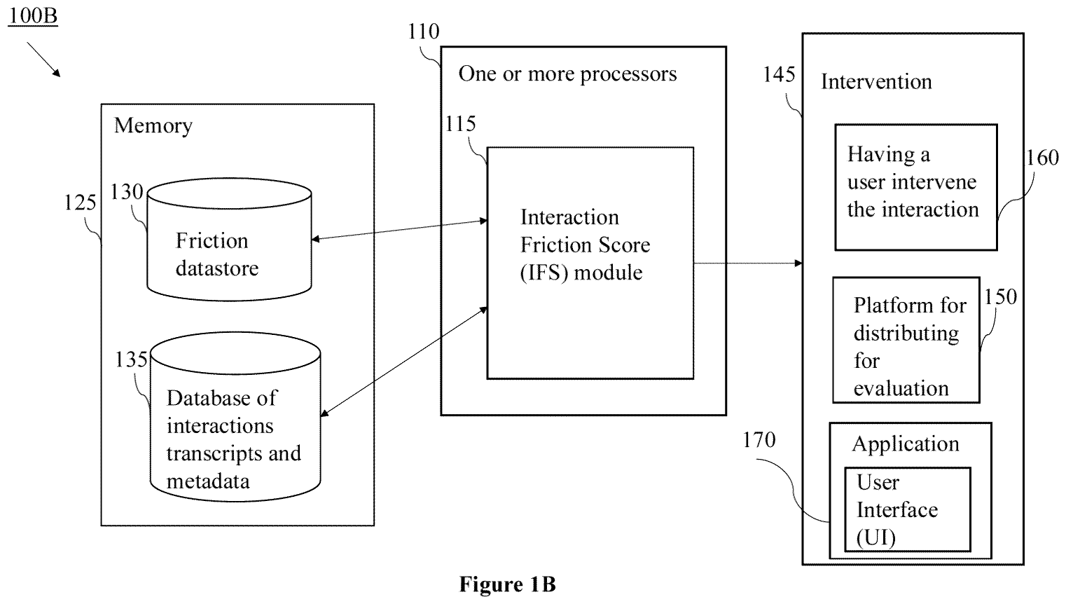

FIG. 1A schematically illustrates a high-level diagram of a computerized-system 100A for calculating a level of friction within a customer and an agent interaction, for quality improvement thereof, in a multichannel contact center, in accordance with some embodiments of the present invention.

According to some embodiments of the present disclosure, in a system, such as computerized system 100A that includes one or more processors 110, a friction datastore 130 and a database of interactions transcripts and metadata 135 and a memory 125 to store the plurality of databases, the one or more processors 110 may be configured to operate, for each interaction between a customer and an agent, in each channel, a module, such as Interaction Friction Score (IFS) calculation module 115. The IFS calculation module 115 may calculate an IFS for the interaction by which for an interaction having an IFS above a calculated Interaction Friction Threshold (IFT) an intervention may be operated.

According to some embodiments of the present disclosure, the IFS calculation module 115 may include retrieving a transcript and interaction metadata of the interaction between the customer and the agent from the friction datastore 130 and the database of interactions transcripts and metadata 135. The transcript may include ‘N’ sentences, i.e., the interaction included ‘N’ sentences. The transcript may be a transcript of a voice interaction or a text-based interaction. The transcript may be fed into a Next sentence prediction ML model, which detects the end of a sentence and predicts the next sentence.

The interaction metadata may include interaction time-offset of each sentence in the interaction and the participants information, e.g., which participant uttered each sentence.

According to some embodiments of the present disclosure, the IFS calculation module 115 may further include calculating an IFS of the interaction between the customer and the agent. The IFS may be calculated by formula I:

$$I F S = {\prod }_{2}^{N} ( {S}_{n - 1} + ( 1 - α ) ) \vert α , {S}_{n} ∈ [ 0 , 1 ] \qquad ( I )$$

whereby: N is the number of sentences in the transcript and Sₙ is a friction score for sentence n, and α is hyper parameter that represents a value that is attributed to a high level of friction.

According to some embodiments of the present disclosure, the IFS calculation module 115 may further include storing the calculated IFS in the friction datastore 130 for later on analysis and then forwarding each interaction between the customer and the agent having a calculated IFS above a calculated Interaction Friction Threshold (IFT) for an intervention 145.

According to some embodiments of the present disclosure, person one-hot vector of sentenceₙ may be a vector in the length of two containing zero and one in any order. The one-hot vector may represent the speaker for each sentence spoken. For example, if there are two persons speaking, e.g., customer and agent then the customer may be represented as [1,0] and the agent may be represented as [0,1]. The length of the vector equals to the number of the participants.

According to some embodiments of the present disclosure, the Sₙ which is the friction score of each sentence may be calculated by a sentence-score module. The sentence-score module may include receiving a sentenceₙ, a person one-hot vector of sentenceₙ, and interaction time-offset of the sentences, a sentenceₙ₋₁ a person one-hot vector of sentenceₙ₋₁, and interaction time-offset of the sentenceₙ₋₁.

According to some embodiments of the present disclosure, the sentence-score module may be calculating a friction-score for the sentence by the following operations: (i) providing the person one-hot vector of sentenceₙ and the person one-hot vector of sentenceₙ₋₁ to a Natural Language Processing (NLP) Tim-Talking model to yield probability vector prediction of sentenceₙ, (ii) calculating a vector-distance between a provided probability vector prediction of sentenceₙ and the person one-hot vector of sentenceₙ, (iii) providing the sentenceₙ₋₁ to a next-sentence-prediction model to yield a predicted-sentenceₙ; (iv) embedding the predicted-sentenceₙ and sentenceₙ using an NLP-embedding-engine module to yield a predicted-sentenceₙ embedding and a sentenceₙ embedding; (v) calculating a distance between the yielded predicted-sentenceₙ embedding and the yielded sentenceₙ embedding; (vi) providing the interaction time-offset of the sentenceₙ₋₁ and interaction time-offset of the sentenceₙ, to nominalized-relative-offset-module to calculate a relative offset between sentenceₙ and sentenceₙ₋₁ by dividing a difference between sentenceₙ and sentenceₙ₋₁ by time-offset of sentenceₙ; and (vii) calculating a weighted average of the calculated vector-distance ‘P’ which is turn talking vector distance, the calculated distance, which is ‘S’ sentence content vector distance and the relative offset ‘T’. The weighted average has a value between ‘0’ and ‘1’, and the weighted average may be the friction score, Sₙ of the sentenceₙ.

According to some embodiments of the present disclosure, the calculated distance between the yielded predicted-sentenceₙ embedding and the yielded sentenceₙ embedding may be selected from Euclidean distance or Cosine distance.

According to some embodiments of the present disclosure, the next-sentence-prediction model may be further provided sentences from sentence₁₊ₘ through sentenceₙ₋₁.

According to some embodiments of the present disclosure, the next-sentence-prediction model may be implemented by an open-source artificial intelligence. The open-source artificial intelligence is Generative Pre-trained Transformer 2 (GPT2).

According to some embodiments of the present disclosure, the embedding of the predicted-sentenceₙ and the sentenceₙ, may be a leaned vector representation for text where sentences are mapped to vectors of real numbers.

According to some embodiments of the present disclosure, the IFT may be calculated for each channel based on historic interactions scores operated in this channel in a preconfigured period.

According to some embodiments of the present disclosure, the IFT may be either individual per agent, or it may be a general calculation for a call center. For an individual IFT per agent the calculation may be an average of IFS scores among ‘N’ interactions of a given agent. For IFT for a contact center the calculation may be more general. For example, when there isn't enough data per agent, the IFT may be based on IFS scores of ‘N’ random interactions involving M random agents.

According to some embodiments of the present disclosure, the NLP Turn-Talking model and the next-sentence-prediction model may be trained on sentence samples which are classified as ‘neutral’. The classification may be implemented by pretrained models, pretrained models which are fined tuned by interaction data, pretrained models by interaction recorded data.

According to some embodiments of the present disclosure, the IFP calculation module may be implemented by a microservice having one or more instances thereof that may operate in parallel.

According to some embodiments of the present disclosure, the friction datastore 130 may include two parts: a cache for ongoing interactions and a database to store classification of the interactions as ‘neutral’ or ‘negative’ and IFS score of interactions classified as ‘negative’.

According to some embodiments of the present disclosure, an agent-IFS may be further calculated based on preconfigured interactions from the database in the friction datastore 130 in a preconfigured time for each agent and the agent-IFS of the agent may be used to categorize the agent based on one or more agent-preconfigured-thresholds. The agent categorization may be used in a Workforce Management system, for example, when the system may be generating diverse shift-schedules by having each generated shift-schedule including agents of two or more agent categorizations.

According to some embodiments of the present disclosure, the calculation of the agent-IFS may be operated by periodically taking ‘N’ interactions of a given agent and checking the associated IFS scores of those ‘N’ interactions and then calculating the average of these IFS scores to yield the agent-IFS.

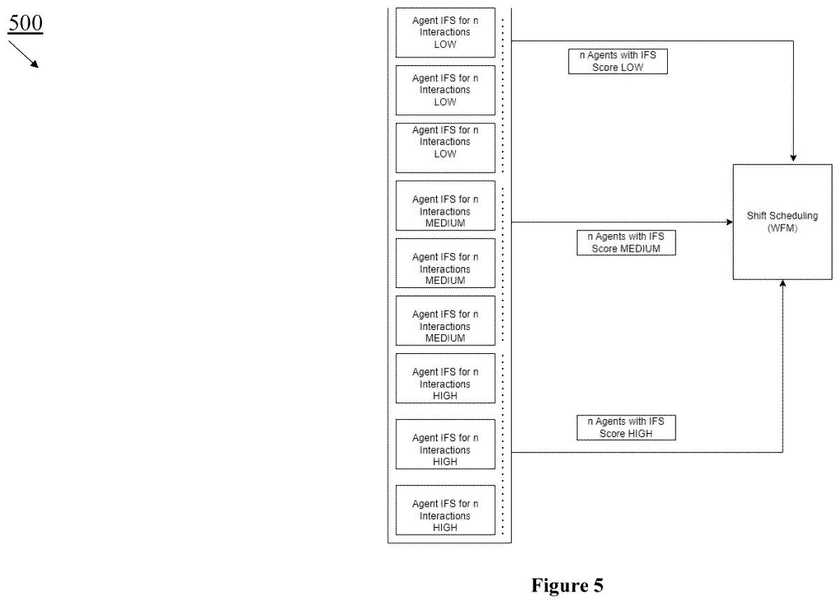

According to some embodiments of the present disclosure, the agent categorization may be selected for example, from: (i) ‘low’; (ii) ‘medium’; and (iii) ‘high’, as shown in FIG. 5. When an agent categorization of the agent is below or equal to a first preconfigured-threshold of the one or more thresholds the agent may be categorized as ‘low’. When the agent categorization of the agent is above the first preconfigured-threshold of the one or more thresholds and below or equal a second preconfigured-threshold the agent may be categorized as ‘medium’ and when the agent categorization of the agent is above the second preconfigured-threshold of the one or more thresholds the agent may be categorized as ‘high’.

According to some embodiments of the present disclosure, in case the interaction is conducted via a voice channel. i.e., a voice call, data buffers may be held using byte-arrays which store binary data, and the data may be transcripted to text for the analysis phase e.g., the calculating an IFS of the interaction between the customer and the agent, by the IFS calculation module 115.

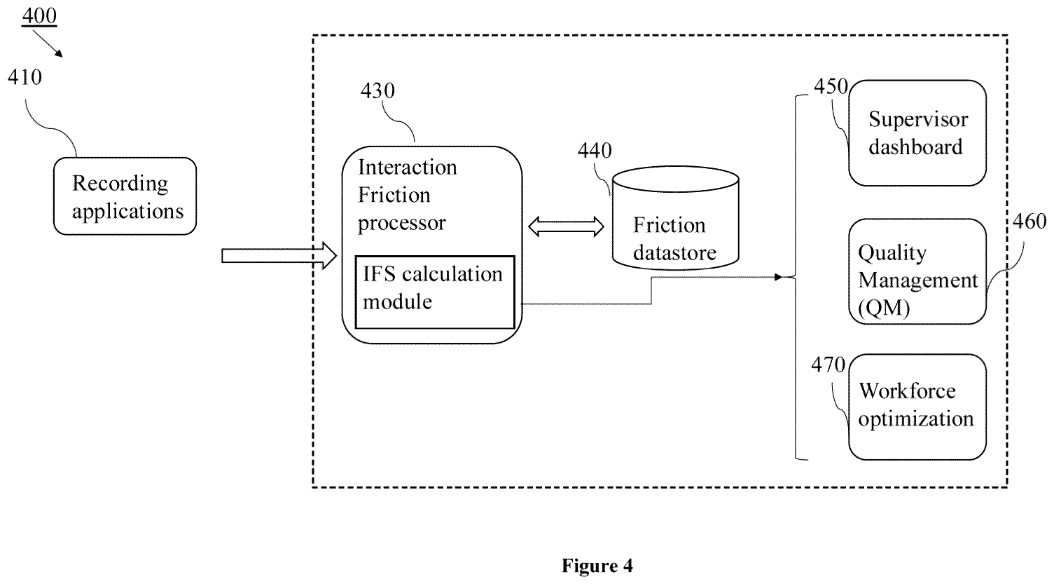

According to some embodiments of the present disclosure, the text of the transcripts or the textual interactions may be held as strings or array of strings that may be fed into the processing service, for example, such as Interaction Friction processor 430 in FIG. 4.

According to some embodiments of the present disclosure, the IFS may have a numeric value. The IFS may be held in a data structure, such as a dictionary, that is mapping a pair of compared measures to their comparison score result. Alternatively, the IFS may be stored as a List as JavaScript Object Notation (JSON) structures or similar.

According to some embodiments of the present disclosure, the interaction metadata may be stored as a complex object. The object may hold lists of information, such as different business data strings. For example, the interaction metadata may be interaction ID, local start time, local stop time, GMT start time, GMT stop time, interaction duration, open reason, close reason, switch ID, user ID, interaction type, media type, dialed number (ANI), participants, contact ID, contact start time, call ID etc.

According to some embodiments of the present disclosure, agent metadata which may include the agent-IFS may be stored as a complex object. Other agent metadata may include ID, tenant ID, CRM reference, gender ID, first name, last name, address, birth date, seniority, nationality, state of origin. OS login etc.

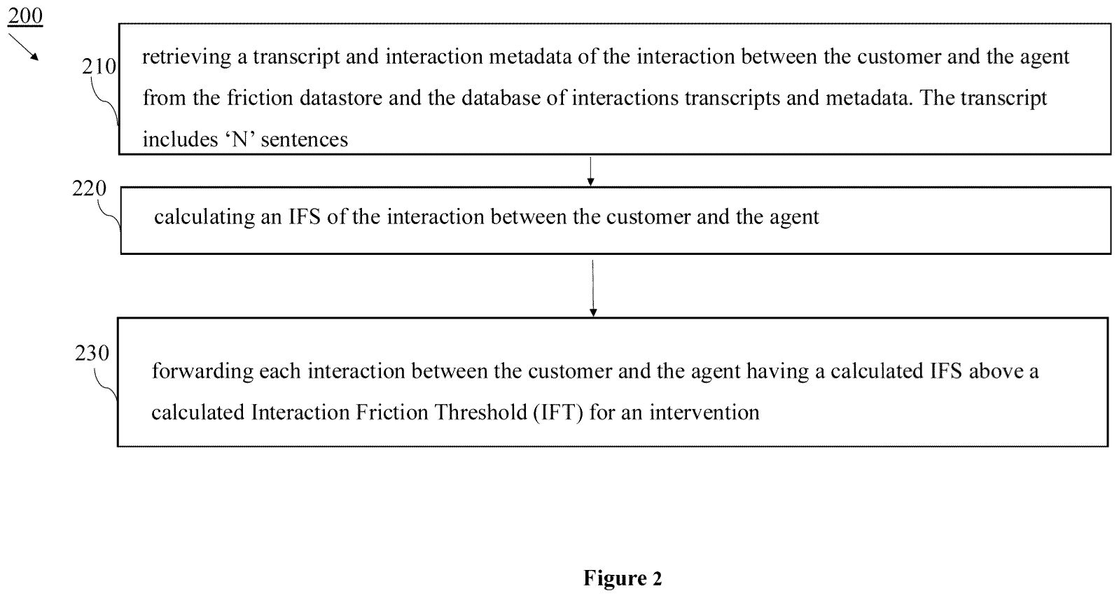

According to some embodiments of the present disclosure, system 100A may implement the operations of computerized-method 200 in FIG. 2.

FIG. 1B schematically illustrates a high-level work-flow on a computerized-system 100B for calculating a level of friction within a customer and an agent interaction, for quality improvement thereof, in a multichannel contact center, in accordance with some embodiments of the present invention.

According to some embodiments of the present disclosure, a system, such as system 100B may include the same components as system 100A in FIG. 1A. Each interaction between the customer and the agent that may have a calculated IFS above a calculated Interaction Friction Threshold (IFT) may be forwarded for an intervention 145.

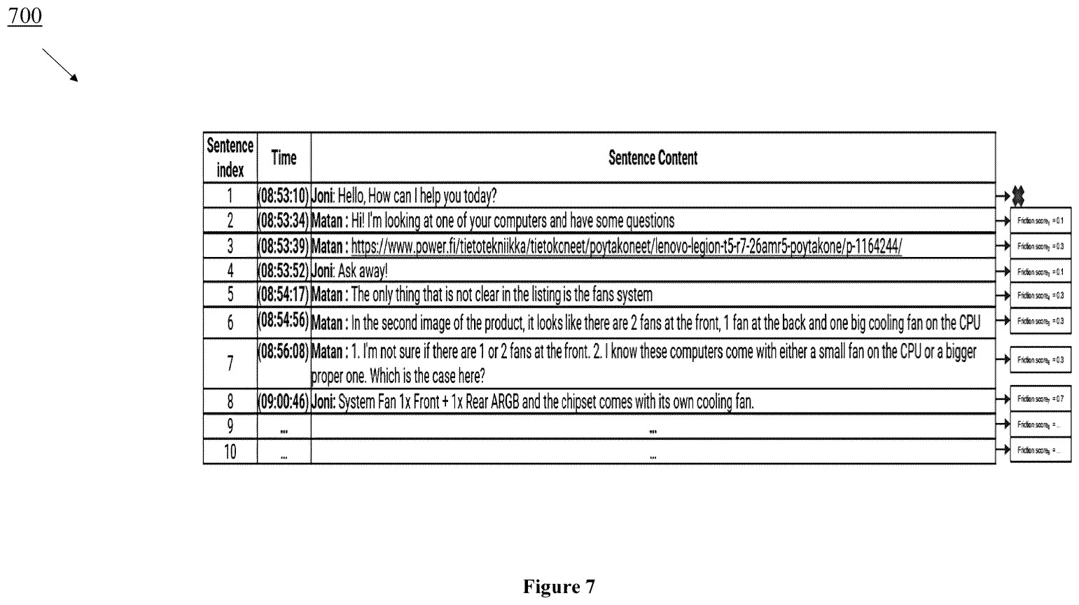

According to some embodiments of the present disclosure, the intervention 145 may include at least one of: (i) having a user intervene the interaction 160 when the IFS module 115 is operated in real-time; (ii) sending the calculated IFS to a platform 150 by which the platform may be preconfigured to distribute the interaction for evaluation, based on the IFS; and (iii) sending the transcript of the interaction to an application 170 to present via a User Interface (U) segments of the interaction where each segment e.g., sentence, may be presented with the calculated IFS, for example, as shown in FIG. 7.

According to some embodiments of the present disclosure, the user intervening the interaction when the IFS module 115 is operated in real-time 160 may include for example, a supervisor who may assist or guide a struggling agent in real-time or may take over the interaction handling altogether.

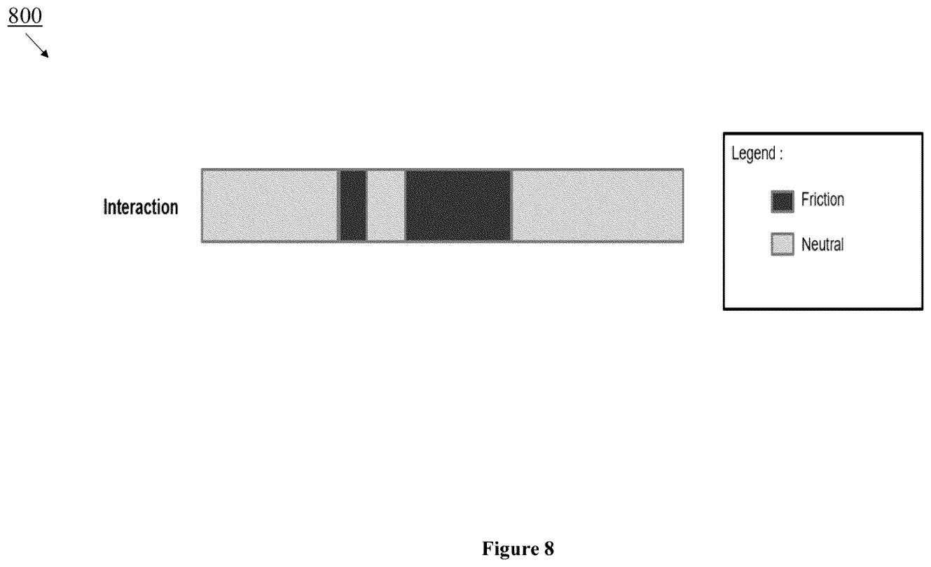

According to some embodiments of the present disclosure, the application 170 may present via a UI all the segments of the interaction, e.g., sentences along with each sentence calculated IFS, i.e., Sₙ. The application 170 may also present, via the UI, a visualization of ‘neutral’ segments and ‘negative’ segments, for example, as shown in FIG. 8.

According to some embodiments of the present disclosure, the application 170 may be a supervised dashboard and the platform 150 may be a Quality Management QM platform. The QM platform may distribute interactions having an IFS above a preconfigured threshold for evaluation and may discard interaction below or equal to the preconfigured threshold, thus filtering interactions for evaluation based on the IFS of the interaction.

According to some embodiments of the present disclosure, the platform 150 may be preconfigured to distribute the interaction for evaluation, based on the IFS. For example, an interaction having an IFS above a preconfigured threshold may be considered as having high level of friction which should be distributed for further evaluation.

FIG. 2 is a schematic flowchart a computerized-method 200 for calculating a level of friction within a customer and an agent interaction, for quality improvement thereof in a multichannel contact center, in accordance with some embodiments of the present invention.

According to some embodiments of the present disclosure, operation 210 comprising retrieving a transcript and interaction metadata of the interaction between the customer and the agent from the friction datastore and the database of interactions transcripts and metadata. The transcript includes ‘N’ sentences.

According to some embodiments of the present disclosure, operation 220 comprising calculating an IFS of the interaction between the customer and the agent

According to some embodiments of the present disclosure, operation 230 comprising forwarding each interaction between the customer and the agent having a calculated IFS above a calculated Interaction Friction Threshold (IFT) for an intervention. For example, the intervention may be such as intervention 145 in FIGS. 1A-1B.

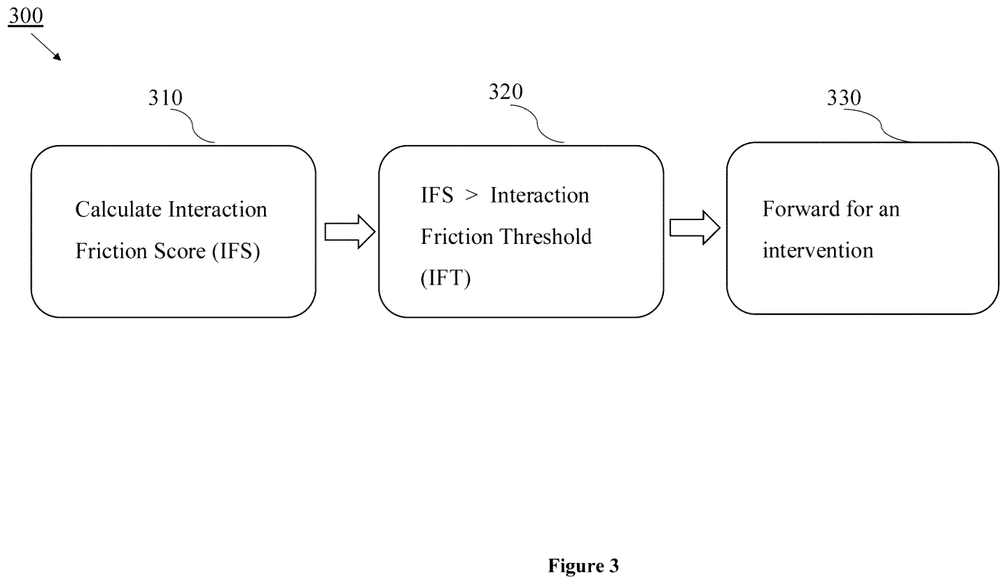

FIG. 3 is a schematic flowchart a computerized-method 300 for calculating a level of friction within a customer and an agent interaction, for quality improvement thereof, in a multichannel contact center, in accordance with some embodiments of the present invention.

According to some embodiments of the present disclosure, in a system, such as computerized-system 100A in FIG. 1A and such as computerized-system 100B in FIG. 1B, friction during agent-customer interactions which are conducted via digital channels may be detected and calculated such that relevant interactions may be flagged for quality management processes.

According to some embodiments of the present disclosure, the Interaction Friction Score (IFS) 310 may represent a level of friction that has occurred within an interaction. The Interaction Friction Threshold (IFT) may represent the maximum permissible friction score for a given interaction.

According to some embodiments of the present disclosure, Machine Learning (ML) components may be used to analyze each sentence of a given interaction. The results of the analysis may be combined into the IFS using two consecutive sentences. The interaction may be flagged based on the comparison of the IFS and the IFT 320.

According to some embodiments of the present disclosure, the detection algorithms, together with the friction score calculation may enable detection of friction during the interaction in real-time and to forward the interaction for an intervention 330. For example, automatically engaging a user in the interaction to advance resolution of arising issues.

According to some embodiments of the present disclosure, the intervention in the interaction may also be by pointing to users, such as QM supervisors to problematic segments in interactions which if addressed properly may save a lot of time and level up quality management.

FIG. 4 is a schematic diagram of a system 400 for calculating a level of friction within a customer and an agent interaction, for quality improvement thereof, in a multichannel contact center, in accordance with some embodiments of the present invention.

According to some embodiments of the present disclosure, in a system such as computerized-system 100A and such as computerized-system 100B, every interaction data that comes in from recording applications 410 may go through an Interaction Friction processor 430. Results of analysis of the Interaction Friction processor 430, e.g., IFS of an interaction and Sₙ of each sentence in the interaction, may be stored in a friction datastore 440.

According to some embodiments of the present disclosure, Interaction Friction processor 430 may include a module, such as IFS calculation module 115 in FIGS. 1A-1B. The Interaction Friction processor 430 may further perform actions such as periodic calculation of IFT, expose an API to receive requests to process interactions and produce scores or results, e.g., compare score to threshold and the like.

According to some embodiments of the present disclosure, interactions, having a calculated IFS above a calculated IFT, may be tagged by the IFS calculation module 430 for future QM processes by a Quality Management (QM) system 460, where coaching packages may be created for the relevant agents, to improve their call handling skills.

According to some embodiments of the present disclosure, the interaction may be in chat or voice form. The IFS calculation module 430 may be implemented as a microservice and there may be several instances of it, all may work in parallel in front of the friction datastore 440 where the interaction's state, e.g., ‘started’, ‘in progress’, ‘ended’, may be kept.

According to some embodiments of the present disclosure, the friction datastore 440 may include two parts, a cache for ongoing interactions and a database for final results of the interactions analysis.

According to some embodiments of the present disclosure, QM system 460 and Workforce optimization 470 may be implemented via web-services and may receive tagged interactions. The tagging of the interactions i.e., saving the IFS score of the interaction in the interaction metadata may be operated by a dedicated Application Programming Interface (API).

According to some embodiments of the present disclosure, the IFS calculation module 430 may operate in real-time and during the interaction may notify a supervisor of current work-shift or automatically join the supervisor or any other user to the interaction to guide the agent or take over and advance the interaction to a resolution of the customer issues.

FIG. 5 is a diagram which illustrates agent categorization 500, in accordance with some embodiments of the present invention.

According to some embodiments of the present disclosure, there may be an integration of computerized-system 100A in FIG. 1A or computerized-system 100B in FIG. 1B with ‘Workforce Management’ system, such as Workforce optimization 470 in FIG. 4. For example, a particular shift schedule may consist of agents with distinct IFSs. Based on the IFS of one or more interactions, agents may be categorized into different levels, e.g., ‘LOW IFS’, ‘MEDIUM IFS’, ‘HIGH IFS’ and shift schedules may be generated by integrating agents across the different IFS categories to create a varied work environment and to increase quality of service.

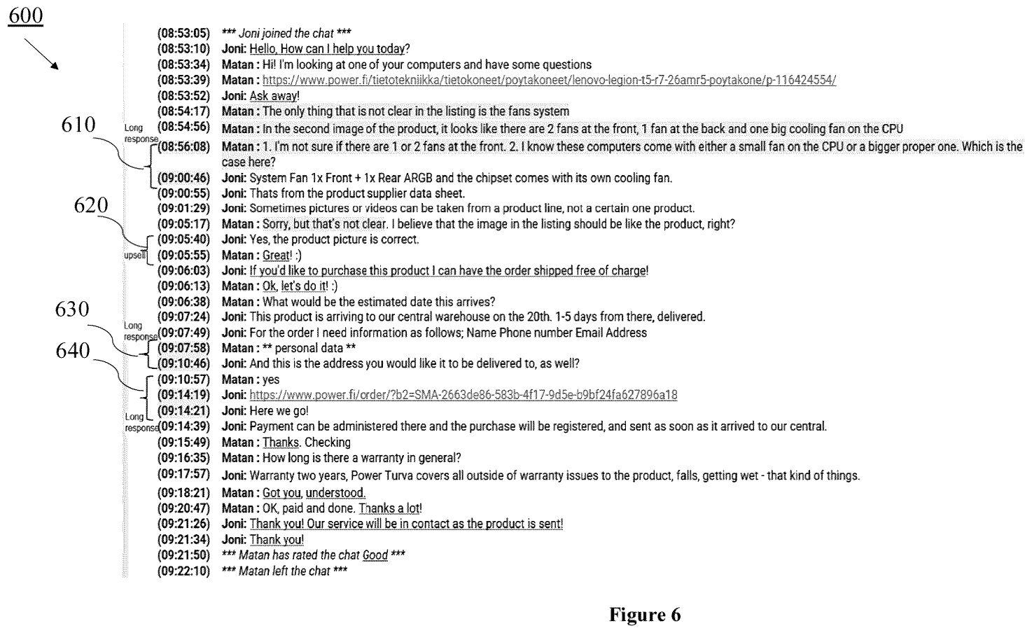

FIG. 6 is an example of interaction friction analysis 600, in accordance with some embodiments of the present invention.

According to some embodiments of the present disclosure, an interaction friction analysis may be operated on a chat interaction where sentences 610, 620, 630 and 640 may be marked as having friction by a module, such as IFS calculation module 115 in FIGS. 1A-1B.

According to some embodiments of the present disclosure, sentence 610 is an example of frustration on customer side and a long response i.e., a delay from the agent. Sentence 620 is an example of a friction in the form of frustration. The customer is wording ‘not clear’ and posts another question which indicates frustration. Sentences 630 and 640 are examples of long response times from the agent.

FIG. 7 is an example of interaction inference 700, in accordance with some embodiments of the present invention.

According to some embodiments of the present disclosure, a friction score may be calculated for each sentence of an interaction starting from the second sentence in the conversation. The friction score value may be between ‘0’ to ‘1’. The value of ‘0’ may indicate that there is no friction and the value of ‘I’ may indicate a high level of fiction.

According to some embodiments of the present disclosure, given an interaction with ‘N’ sentences, there may be N−1 friction scores (Sₙ). Each friction score may be with index n (n=[2, 3, . . . , N−1]). An overall Interaction Friction Score (IFS) may be calculated which may consider sequences of Sₙ₋₁ and Sₙ, i.e., sentences, of high friction, because a sequence of 10 high friction scores, i.e., sentences is worse than 10 scattered high friction scores, in the conversation. The sequence may be considered by the calculation of IFS by formula I below. The autoregressive formula I specifies that the output variable depends linearly on its own previous values and on a stochastic term e.g., an imperfectly predictable term, thus, the Interaction Friction Score (IFS) module is in the form of a stochastic difference equation or recurrence relation which is not a differential equation.

According to some embodiments of the present disclosure, the IFS may be calculated by formula (I):

$$I F S = {\prod }_{2}^{N} ( {S}_{n - 1} + ( 1 - α ) ) \vert α , {S}_{n} ∈ [ 0 , 1 ] \qquad ( I )$$

whereby: N is the number of sentences in the transcript and Sₙ is the friction score for sentence n, α is hyper parameter that represents the value that is considered to be high friction. For example, when α=0.6, then formula I may be equal to

$$I F S = {\prod }_{2}^{N} ( {S}_{n - 1} + 0.4 )$$

Using this high-resolution information, a conversation friction plot may be built, for example, as shown in FIG. 8.

FIG. 8 is a visualized interaction friction 800, in accordance with some embodiments of the present disclosure.

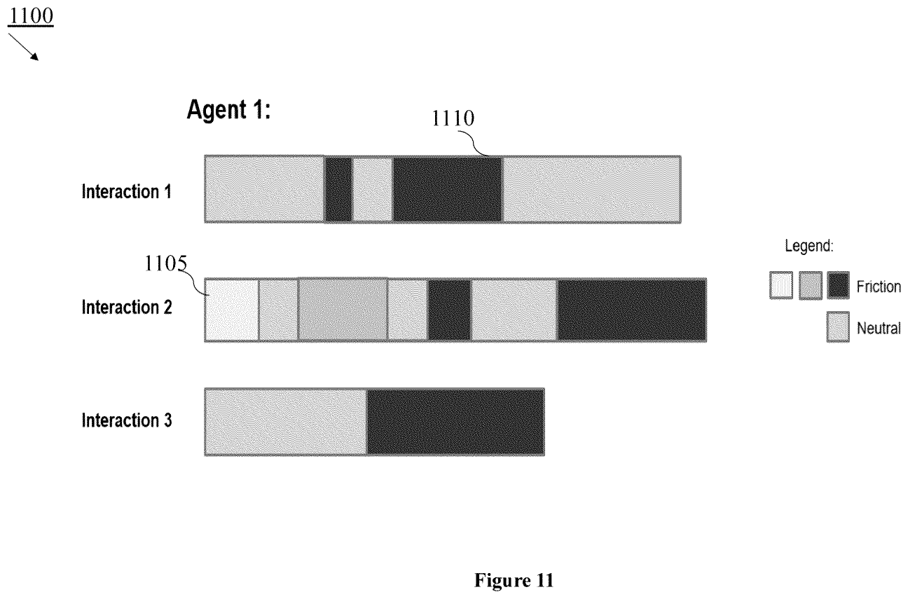

According to some embodiments of the present disclosure, each interaction may be visualized as having ‘neutral’ segments and segments with various levels of friction via a UI of an application. For example, application 170 in FIG. 1B. For example, as shown in FIG. 11.

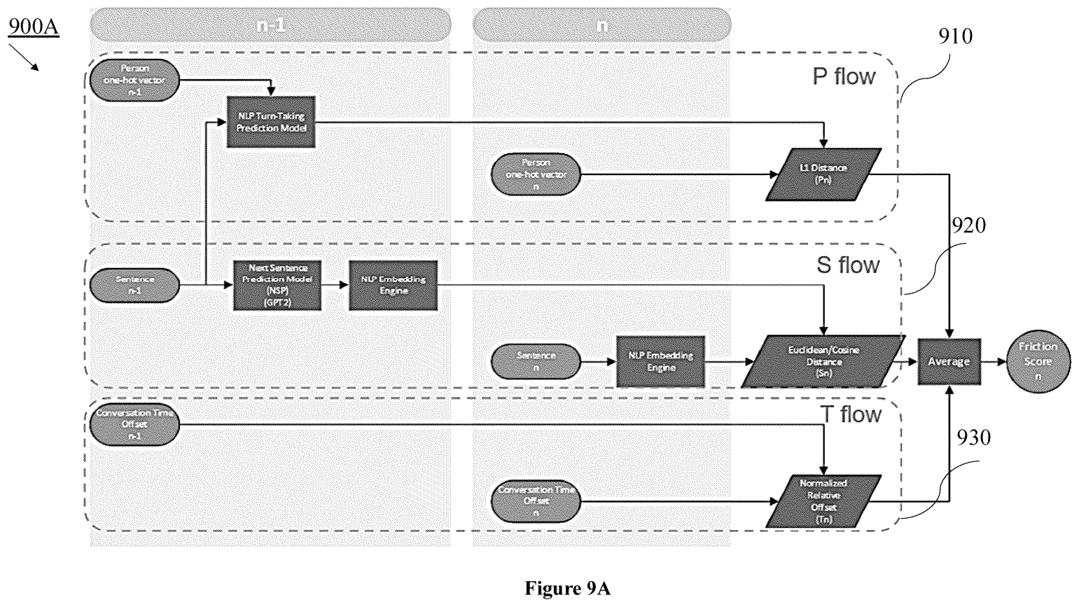

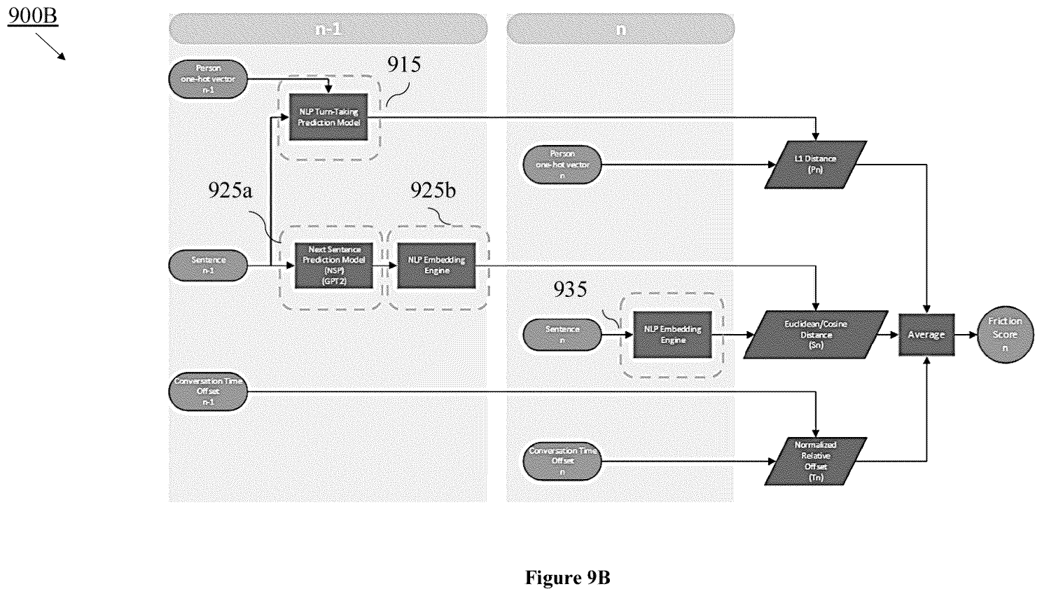

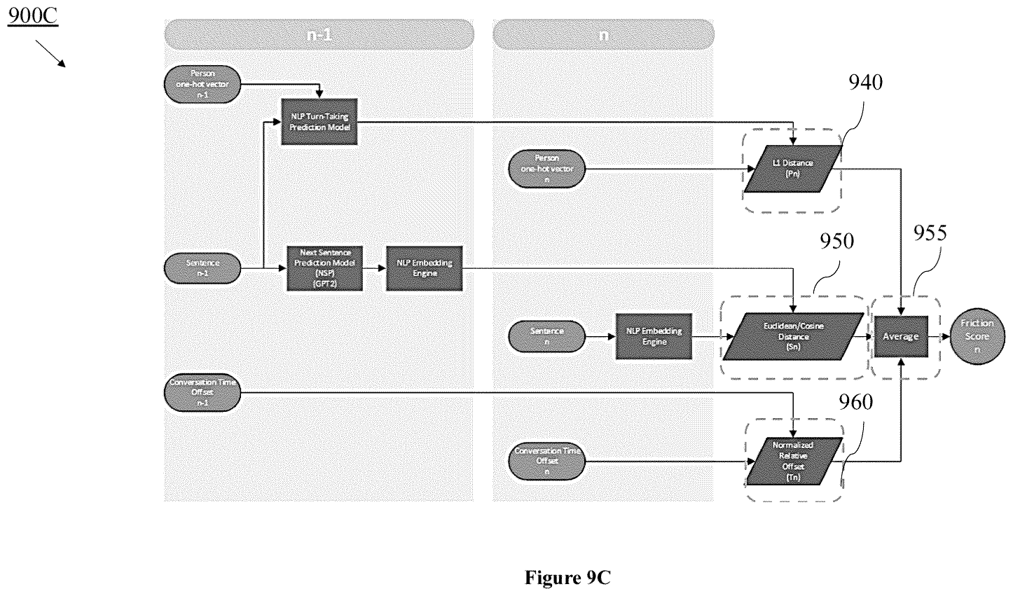

FIG. 9A is a high-level work-flow 900A of a computerized-method for calculating a level of friction within a customer and an agent interaction, for quality improvement thereof, in a multichannel contact center, in accordance with some embodiments of the present disclosure.

According to some embodiments of the present disclosure, the input per sentence may be Person one-hot vectorₙ which is a vector having two bits with a value of ‘0’ or ‘1’ sentenceₙ which is the n sentence and an interaction time offsetₙ which is an integer representing seconds from the start of the conversation to sentence n. The output per sentence may be a friction score Sₙ having a value between ‘0’ to ‘1’, where a higher value indicates a higher friction during the interaction.

According to some embodiments of the present disclosure, in a system, such as system 100A in FIG. 1 and such as system 100B in FIG. 1B, a calculation of a friction score of Sₙ may include three sub-flows, ‘P flow’ 910, ‘S flow’ 920 and ‘T flow’ 930 which may consider input from current sentence n and previous sentence n−1. In the ‘P flow’ 910 friction is detected based on Turn-Talking where if one participant talks more or less than compared to a normal or probable conversation.

According to some embodiments of the present disclosure, the NLP Turn-Talking model may be trained to identify normal conversation by using conversations to statistically model the relationship between conversational speakers.

According to some embodiments of the present disclosure, in the ‘S flow’ 920 friction is detected based on content in the interaction where the content of a sentence is compared to a normal or probable conversation.

According to some embodiments of the present disclosure, the next sentence prediction module may be trained by using conversation to statistically model the relationship between conversational sentences.

According to some embodiments of the present disclosure, in the ‘T flow’ 930 friction is detected based on delay between sentences where the higher the delay between sentences the higher the friction.

According to some embodiments of the present disclosure, in the ‘P flow’ 910 one-hot vector, represents the speaker for each sentence spoken, for example, when there are two speakers, customer and agent, the customer may be represented as [1,0] and the agent may be represented by [0,1]. The length of the vector may equal the number of participants. The one-hot vector may be given as input, then this vector is fed into a Natural Language Processing (NLP) model, such as turn-taking prediction module along with the n−1 sentence. This module may output probability vector prediction of the next sentence speaker. Next, the system gets the n person one-hot vector and calculates the ‘L1’ distance between a given person one-hot vector and the predicted one-hot vectorₙ.

According to some embodiments of the present disclosure, in the ‘S flow’ 920 sentence n−1 is given as input, then it is fed into the next sentence prediction module which may predict the next sentence. The predicted sentence is then embedded using the NLP embedding engine module. Next, sentence n is embedded using the NLP Embedding Engine module. Once we have sentence n embedding and the predicted sentence n embedding the system calculates the Euclidean distance or Cosine distance between them.

According to some embodiments of the present disclosure, in the ‘T flow’ 930 interaction time offset n−1 is provided with sentence n−1. Then, interaction time offset n is provided with sentence n. Both offsets may be fed into a normalized-relative-offset-module, which may calculate the relative offset between sentence n−1 and sentence n. The difference may be divided by the time from the interaction start to sentence n.

According to some embodiments of the present disclosure, an average of the three outputs of ‘P flow’ 910, ‘S flow’ 920 and ‘T flow’ 930 may be calculated into a value between ‘0’ to ‘1’ which represents the friction score of sentence n, Sₙ.

FIG. 9B is a high-level work-flow 900B of a computerized-method for calculating a level of friction within a customer and an agent interaction, for quality improvement thereof, in a multichannel contact center, in accordance with some embodiments of the present disclosure.

According to some embodiments of the present disclosure, the NLP turn-taking prediction module 915 may receive a person indication one-hot vector as input. The output may be a vector of the same size as the input vector with probabilities for each element or cell in the vector. Each cell contains probability for the person who should talk next. The value of the cells in the vector may sum to 1, for example 0.3+0.7.

According to some embodiments of the present disclosure, the next sentence prediction model (NSP) 925a which may be implemented by Generative Pre-trained Transformer 2 (GPT2) may receive previous sentence or all conversation until the current sentence include. The output may be the next sentence. The GPT2 is an open-source artificial intelligence created by OpenAI in February 2019.

According to some embodiments of the present disclosure, the NLP embedding engine 925b or 935 may receive a sentence and the output may be a sentence representation. The sentence embedding may be a learned vector representation for text where sentences that have the same meaning have a similar representation.

According to some embodiments of the present disclosure, training of the NLP turn-taking prediction module 915 and the next sentence prediction model 925a may be on frictionless interaction samples. This may set the prediction to a non-friction likely outcome. The NLP embedding engine trained using random samples of interactions regardless for friction.

FIG. 9C is a high-level work-flow 900C of a computerized-method for calculating a level of friction within a customer and an agent interaction, for quality improvement thereof, in a multichannel contact center, in accordance with some embodiments of the present disclosure.

According to some embodiments of the present disclosure, normalized ‘L1’ distance (Pn) 940 may be yielded by receiving person one-hot vector n and a probability vector for next person prediction. The normalized ‘L’ distance 940 may be a value between ‘0’ to ‘1’ which may indicate the distance between the current speaker and the predicted speaker. The distance may be selected from Euclidean distance or Cosine distance.

According to some embodiments of the present disclosure, the ‘L1’ distance 940 may be normalized by the normalization of a vector v with respect to a norm ∥·∥ is given by

$$y = \frac{v}{‖ v ‖} .$$

This new vector y has the following properties:
1. it has norm one, meaning that ∥y∥=1; and
2. it has the same direction as the original vector v, meaning that v is proportionate to y.

According to some embodiments of the present disclosure, normalized Euclidean/Cosine Distance (Sₙ) 950 of sentence n may be yielded by receiving current sentence embedding and predicted sentence embedding. The Euclidean/Cosine Distance 950 may have a value between ‘0’ to ‘1’ represents the distance between the embeddings.

According to some embodiments of the present disclosure, the Euclidean/Cosine Distance (Sn) 950 may be normalized

by the normalization of a vector v with respect to a norm ∥·∥ is given by

$$y = \frac{v}{‖ v ‖} .$$

This new vector y has the following properties:
1. it has norm one, meaning that ∥y∥=1; and 2, it has the same direction as the original vector v, meaning that v is proportionate to y.

According to some embodiments of the present disclosure, normalized relative offset (Tn) 960 may be yielded by receiving time value in sec/ms for current sentence and time value in sec/ins for previous sentence. The normalized relative offset 960 may indicate relevant time delay between the previous and current sentence. It may be calculated by

$${T}_{n} = \frac{{t}_{n} - {t}_{n - 1}}{{t}_{n - 1}} ,$$

and its value which may be a value between ‘0’ to ‘1’. The relative offset 960 may be normalized by dividing the difference using tₙ₋₁.

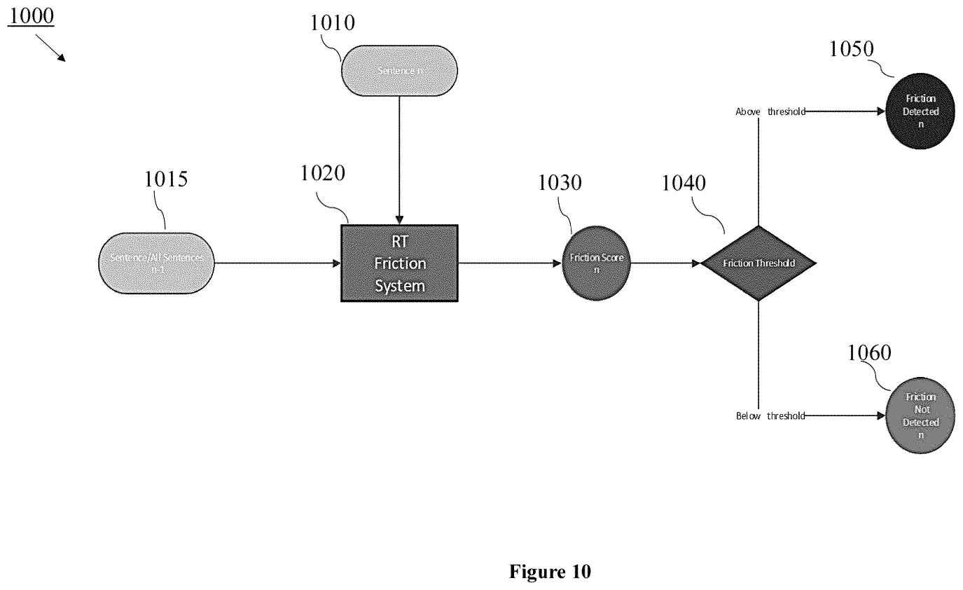

FIG. 10 is a schematic flowchart 1000 of a real-time friction analysis, in accordance with some embodiments of the present disclosure.

According to some embodiments of the present disclosure, for every sentence n−1 1015 and sentence n 1010 using a real-time (RT) friction system, such as Interaction Friction Score (IFS) module 115 in FIGS. 1A-1B to calculate a friction score n 1030 and then compare the friction score n 1030 to a friction threshold 1040. If the friction score n is above the friction threshold an intervention, such as intervention 145 in FIG. 1B may be operated. Otherwise, if the friction score n is below the friction threshold then the interaction may be further monitored. A default value for the friction threshold may be set to 0.6.

According to some embodiments of the present disclosure, because the friction score n is an average of three tests i.e., L1 distance (Pn) 940 in FIG. 9C, Eucledian/Cosain distance (Sn)950 in FIG. 9C and normalized relative offset (Tn) 960 in FIG. 9C, then if the average is above 0.6 it may indicate that at least two of the tests have high indication for friction.

FIG. 11 is an example 1100 of visual friction dashboard in accordance with some embodiments of the present disclosure.

According to some embodiments of the present disclosure, a user interface such as user interface 1100 may visualize all the interactions of a certain agent with the level of friction within, the exact time during the interaction, where the friction was detected and its level. A user may be enabled to click on the friction zone to trigger playback of the interaction and jump directly to the problematic area.

According to some embodiments of the present disclosure, the list of the n sentences in the interaction, may be ranked and sorted according to a level of friction e.g., Sₙ. The friction resolution level as illustrated, may be configurable and can be made higher. Friction levels may be visually illustrated within an interaction by plotting them according to the calculated friction score of each sentence, e.g., Sₙ. For example, the light area 1105 may designate a low friction level and the black area 1110 may designate a high friction level. The number of friction levels and associated shades may be configurable.

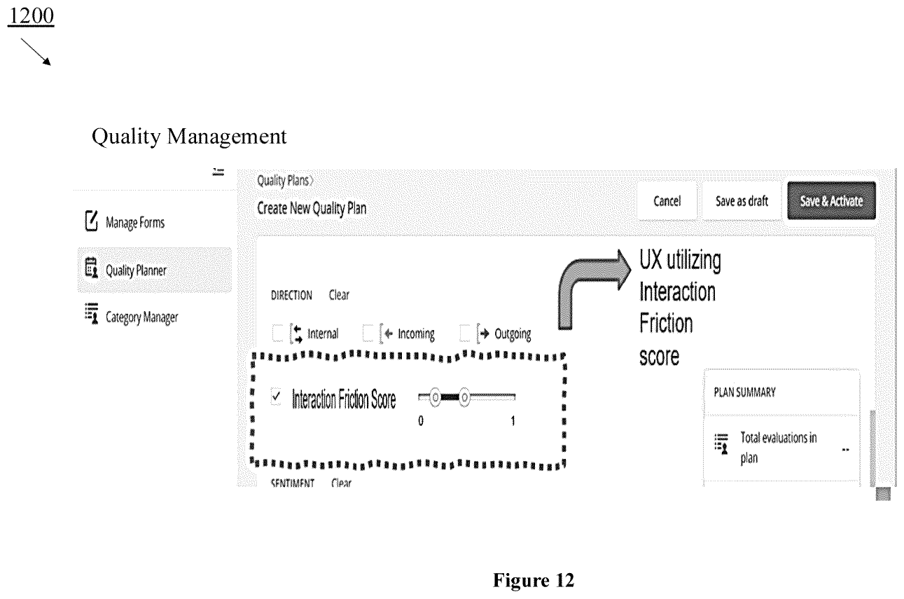

FIG. 12 is an example of an interface 1200 for IFS utilization to create a new quality plan, in accordance with some embodiments of the present disclosure.

According to some embodiments of the present disclosure, a user such as a quality manager or a supervisor may configure a quality plan to select a specific range of agents Interaction Friction Score (IFS) from the slider. This may be utilized as a filter while distributing interactions for evaluation thereof. A quality plan may distribute for evaluation only recorded interactions in which agents repeat call KPI score is, for example between 0.2 and 0.5. The evaluation of such interactions may be beneficial in various situations. For example, it may act as a data-point for the evaluator to perform evaluations for root cause into agent performance issues and lack of knowledge. In another example, it may assist in the assignment of coaching or training program for further improvement.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for calculating a level of friction within a customer and agent interaction, for quality improvement thereof, in a multichannel contact center, said computerized-method comprising:
in a computerized system comprising one or more processors, a friction datastore and a database of interactions transcripts and metadata; and a memory to store the plurality of databases,
said one or more processors are configured to operate, for each interaction between the customer and the agent, in each channel, an Interaction Friction Score (IFS) calculation module, said IFS calculation module comprising:
retrieving a transcript and interaction metadata of the interaction between the customer and the agent from the friction datastore and the database of interactions transcripts and metadata,
wherein the transcript includes ‘N’ sentences,
calculating an IFS of the interaction between the customer and the agent by formula I:
$$I F S = {\prod }_{2}^{N} ( {S}_{n - 1} + ( 1 - α ) ) \vert α , {S}_{n} ∈ [ 0 , 1 ] \qquad ( I )$$
whereby:
Sₙ, is a friction score for sentence n,
α is hyper parameter that represents a value that is attributed to a high level of fiction; and
forwarding each interaction between the customer and the agent having a calculated IFS above a calculated Interaction Friction Threshold (IFT) for an intervention.

2. The computerized-method of claim 1, wherein the Sₙ of each sentence is calculated by a sentence-score module, said sentence-score module comprising:
receiving a sentenceₙ, a person one-hot vector of sentenceₙ, and interaction time-offset of the sentenceₙ, a sentenceₙ₋₁, a person one-hot vector of sentenceₙ₋₁, and interaction time-offset of the sentenceₙ₋₁;
calculating a friction-score for the sentence by:
providing the person one-hot vector of sentenceₙ and the person one-hot vector of sentenceₙ₋₁ to a Natural Language Processing (NLP) Turn-Talking model to yield probability vector prediction of sentenceₙ;
calculating a vector-distance between a provided probability vector prediction of sentenceₙ and the person one-hot vector of sentenceₙ;
providing the sentenceₙ₋₁ to a next-sentence-prediction model to yield a predicted-sentenceₙ;
embedding the predicted-sentenceₙ and sentenceₙ using an NLP-embedding-engine module to yield a predicted-sentenceₙ embedding and a sentenceₙ embedding;
calculating a distance between the yielded predicted-sentenceₙ embedding and the yielded sentenceₙ embedding;
providing the interaction time-offset of the sentenceₙ₋₁ and interaction time-offset of the sentenceₙ to normalized-relative-offset-module to calculate a relative offset between sentenceₙ and sentenceₙ₋₁ by dividing a difference between sentenceₙ and sentenceₙ₋₁ by time-offset of sentenceₙ; and
calculating a weighted average of the vector-distance, distance and the relative offset, wherein the weighted average has a value between ‘0’ and ‘1’, and wherein the weighted average is the Sₙ of the sentenceₙ.

3. The computerized-method of claim 2, wherein the distance is selected from: an Euclidean distance; or a Cosine distance.

4. The computerized-method of claim 2, wherein said next-sentence-prediction model is further provided sentences from sentence₁₊ₘ through sentenceₙ₋₁.

5. The computerized-method of claim 2, wherein said next-sentence-prediction model is implemented by an open-source artificial intelligence.

6. The computerized-method of claim 5, wherein the open-source artificial intelligence is Generative Pre-trained Transformer 2 (GPT2).

7. The computerized-method of claim 2, wherein the embedding of the predicted-sentenceₙ and the sentenceₙ is a learned vector representation for text.

8. The computerized-method of claim 1, wherein the IFT is calculated for each channel based on historic interactions scores operated in this channel in a preconfigured period.

9. The computerized-method of claim 2, wherein the NLP Turn-Talking model and the next-sentence-prediction model are trained on sentence samples which are classified as ‘neutral’.

10. The computerized-method of claim 1, wherein the intervention comprising at least one of: (i) having a user intervene the interaction when the IFS module is operated in real-time; (ii) sending the calculated IFS to a platform by which said platform is preconfigured to distribute the interaction for evaluation, based on the IFS; and (iii) sending the transcript of the interaction to an application to present via a User Interface (UI) segments of the interaction wherein each segment is presented with the calculated IFS.

11. The computerized-method of claim 10 wherein the application presents via the UI a visualization of ‘neutral’ segments and ‘negative’ segments.

12. The computerized-method of claim 10, wherein the application is a supervised dashboard and wherein the platform is a Quality Management QM platform.

13. The computerized-method of claim 1, wherein the transcript is a transcript of a voice interaction or a text interaction.

14. The computerized-method of claim 1, wherein the IFP calculation module is a microservice having one or more instances thereof that operate in parallel.

15. The computerized-method of claim 1, wherein the friction datastore comprising two parts: a cache for ongoing interactions and a database to store classification of the interactions as ‘neutral’ or ‘negative’ and IFS score of interactions classified as ‘negative’.

16. The computerized-method of claim 15, wherein the computerized-method further comprising calculating an agent-IFS based on a preconfigured interactions from the database in the friction datastore in a preconfigured time for each agent and wherein the agent-IFS of the agent is used to categorize the agent based on one or more agent-preconfigured-thresholds.

17. The computerized-method of claim 16, wherein the agent categorization is used in a Workforce Management when generating shift-schedules by having each generated shift-schedule including agents of two or more agent categorizations.

18. The computerized-method of claim 16, wherein the agent categorization is selected from: (i) ‘low’; (ii) ‘medium’; and (iii) ‘high’, wherein when an agent categorization of the agent is below or equal to a first preconfigured-threshold of the one or more thresholds the agent is categorized as ‘low’, wherein when the agent categorization of the agent is above the first preconfigured-threshold of the one or more thresholds and below or equal a second preconfigured-threshold the agent is categorized as ‘medium’ and wherein when the agent categorization of the agent is above the second preconfigured-threshold of the one or more thresholds the agent is categorized as ‘high’.

19. A computerized-system for calculating a level of friction within a customer and an agent interaction, for quality improvement thereof, in a multichannel contact center, said computerized-system comprising:
one or more processors;
a database of data related to interaction metadata and a friction datastore; and
a memory to store the plurality of databases,
said one or more processors are configured to operate, for each interaction between the customer and the agent, in each channel an Interaction Friction Score (IFS) calculation module, said IFS calculation module comprising:
retrieving a transcript and interaction metadata of the interaction between the customer and the agent from the friction datastore and the database of interactions transcripts and metadata,
wherein the transcript includes ‘N’ sentences,
calculating an IFS of the interaction between the customer and the agent by formula I:
$$I F S = {\prod }_{2}^{N} ( {S}_{n - 1} + ( 1 - α ) ) \vert α , {S}_{n} ∈ [ 0 , 1 ] \qquad ( II )$$
whereby:
Sₙ is a friction score for sentence n,
α is hyper parameter that represents a value that is attributed to a high level of friction; and
forwarding each interaction between the customer and the agent having a calculated IFS above a calculated Interaction Friction Threshold (IFT) for an intervention.
